(19) United States
(12) Patent Application Publication
(10) Pub. No.: US 2020/0231123 A1
(43) Pub. Date: Jul. 23, 2020

(54) INTELLIGENT ANTI-THEFT KEY SYSTEM AND METHOD OF OPERATING THE SAME

(71) Applicants: FU DING PRECISION COMPONENT (SHEN ZHEN) CO., LTD., Shenzhen (CN); FOXCONN INTERCONNECT TECHNOLOGY LIMITED, Grand Cayman (KY)

(72) Inventor: CHUNG-NAN KO, New Taipei (TW)

(21) Appl. No.: 16/745,379

(22) Filed: Jan. 17, 2020

(30) Foreign Application Priority Data
Jan. 18, 2019 (CN) 201910047370.3

(51) Int. Cl. B60R 25/24; G06F 21/32; B60R 25/045; B60R 25/25

(52) U.S. Cl. CPC B60R 25/24; G06F 21/32; B60R 2325/205; B60R 25/25; B60R 25/045

(57) ABSTRACT

A vehicle intelligent anti-theft key system and a method operating the same are operated via a two-stage authentication. The first stage authentication is the conventional car key section certification, and the second stage authentication is a newly added preset condition certification. The preset condition can be regarding the time and/or the place, e.g., parking in a parking lot coordinated by the GPS (Global Positioning System) from 9 p.m. to 8 a.m., which is set according to the car owner's live schedule. Even if the thief may use the high-tech replication method to pass the first stage car key section certification, the thief may not be able to pass the second stage preset condition certification due to objective inconsistency.

### BACKGROUND OF THE DISCLOSURE

### 1. Field of the Disclosure

The present disclosure relates to an intelligent anti-theft key system and the corresponding operation method, and particularly to using two-step verification procedure for starting operation of the vehicle.

### 2. Description of Related Arts

Most of the car keys on the market today use PKE/RKE (Passive Keyless Entry/Remote Keyless Entry) electronic car key system. Although it is easy to use, it is not actually safe. Thieves can steal vehicles by using high-tech means, such as scanners or signal relays operating around/between the car and the car owner's house without damaging the vehicle or necessity of getting the key or intruding into the house, etc., but only silently unlocking the door and starting the engine. At present, there are no really effective countermeasures for the car makers.

An efficient method and the desired to provide an reliable anti-theft key system for the vehicle.

### SUMMARY OF THE DISCLOSURE

An object of the invention is to provide a vehicle intelligent anti-theft key system and a method operating the same with two-stage authentication. The first stage authentication is the conventional car key section certification, and the second stage authentication is a newly added preset condition certification. The preset condition can be regarding the time and/or the place, e.g., parking in a parking lot coordinated by the GPS (Global Positioning System) from 9 p.m. to 8 a.m., which is set as the car owner's schedule. Even if the thief may use the high-tech replication method to pass the first stage car key section certification, the thief may not be able to pass the second stage preset condition certification. In other words, the thief still may not unlock the car door and/or ignite the engine. Understandably, the second stage authentication conditions can be reset or overwritten by means of the center console of the vehicle, the APP of the mobile phone or the tablet, the intelligent key or the computer web site of the vehicle network.

Other objects, advantages and novel features of the disclosure will become more apparent from the following detailed description when taken in conjunction with the accompanying drawings.

### BRIEF DESCRIPTION OF THE DRAWINGS

FIG. 1 is a flow chart of an intelligent anti-thief key system for the vehicle according to the invention; and

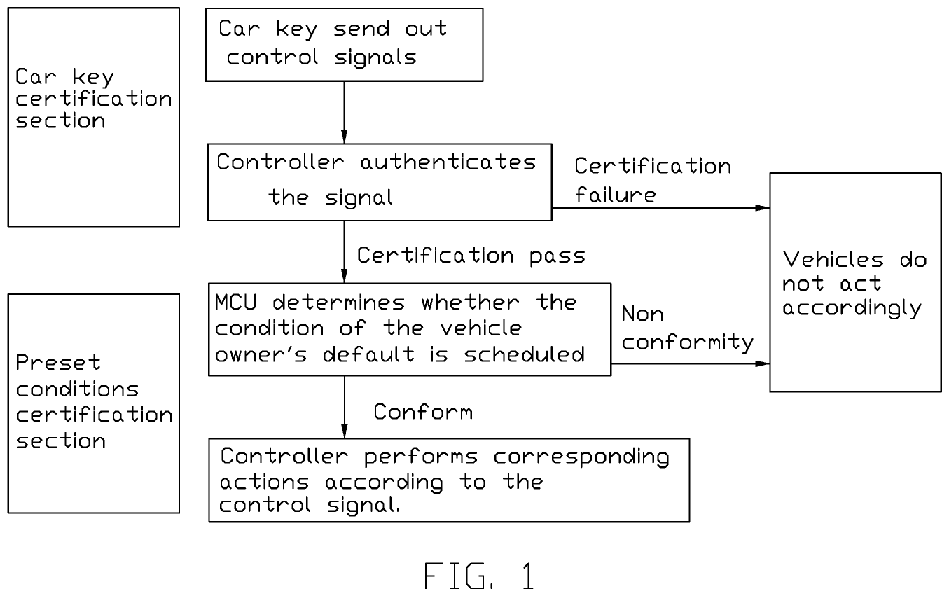

FIG. 2 is a chart of the operation system of FIG. 1.

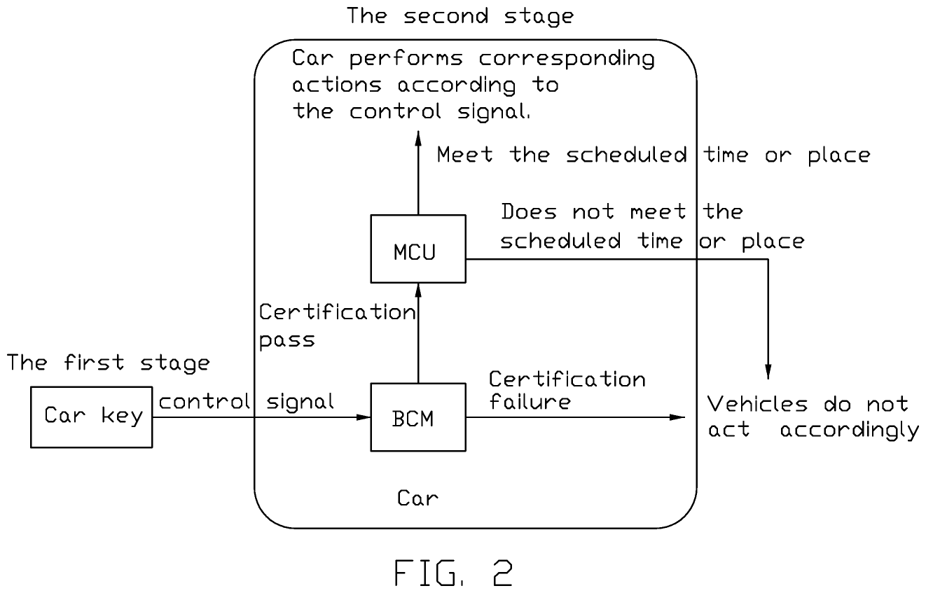

### DETAILED DESCRIPTION OF THE PREFERRED EMBODIMENT

The intelligent anti-thief key system is built within the car and includes operations for both a first stage authentication and a second stage authentication wherein the first stage authentication is the car key verification while the second stage authentication is the preset condition verification. The two-stage authentication may lower the stolen risk.

The system is connected to a mobile device and a center console so as to reset or overwrite the preset conditions. Specifically, the mobile device can be the smart key, the mobile phone, the tablet, the APP of the Internet of Vehicle wherein the mobile device may be built within the car optionally. The connection between the car and the mobile device may be connected through the blue tooth, USB (Universal Serial Bus) or WIFI.

In the first stage authentication, the car key sends the signal and the BCM (Body Control Module) verifies the signals. If failed, nothing happens. If matched, it goes to the second stage authentication stage. In the second stage authentication, the MCU (Microcontroller unit) verifies the actual conditions to see whether matched with the preset conditions, e.g., the scheduled time, the determined location, and/or the live information including the touch ID or face ID. For example, the preset time period is from 9 pm to 8 am for complying with the car owner's living schedule, and the predetermined location is the parking lot beside the car owner's housing. Any non-compliance verified in the second stage authentication will result in no action of the vehicle including unlocking the car door and/or igniting the engine. The preset conditions may be reset or overwritten by means of the center console of the vehicle, the APP of the mobile phone or the tablet, the intelligent key or the computer web site of the vehicle network.

The method of performing the anti-thief process includes the following steps:

Firstly, the system provides a two-stage authentication with a first stage authentication related to the car key verification and a second stage authentication related to the predetermined condition verification wherein in the first state authentication, a signal transmitted by a car key is verified by the BCM to confirm whether the car key is the correct one. If yes, it goes to the second stage authentication. If not, no action can be taken by the car, including unlocking the car door and/or starting the engine.

Secondly, in the second stage authentication, the MCU further verifies whether the actual conditions meet the preset conditions including the scheduled time, the determined location, and/or the drive's personal physical identification, e.g., the touch ID or the face ID. If yes, the car door can be unlocked and the engine can be started. If not, no action can be taken by the car, including unlocking the car door and/or igniting the engine.

In conclusion, through the two-stage authentication, the car has less risk to be stolen even if the car key is improperly replicated by the thief.

While a preferred embodiment in accordance with the present disclosure has been shown and described, equivalent modifications and changes known to persons skilled in the art according to the spirit of the present disclosure are considered within the scope of the present disclosure as described in the appended claims.

What is claimed is:

1. An intelligent anti-thief key system for a vehicle comprising:
a BCM (Body Control module) receiving a signal transmitted from a car key to verify correctness of said signal in a first stage authentication; and
a MCU (Microcontroller unit) comparing instant conditions with the preset conditions including a time condition or a location condition in a second stage authentication only after the signal is verified to be the correct one; wherein
the car will take no action including unlocking car doors or igniting an engine of the vehicle, if verification fails in either stage authentication.

2. The intelligent anti-thief key system as claimed in claim 1, wherein the BCM is connected with a mobile device and a central console to reset the preset conditions.

3. The intelligent anti-thief key system as claimed in claim 1, wherein the preset conditions further include a touch ID or face ID.

4. A method of performing an intelligent anti-thief function for a vehicle, comprising steps of:
providing a first module to receive a signal transmitted from a car key to verify correctness of said signal in a first stage authentication;
providing a second module to compare instant environmental conditions with preset environmental conditions including a time condition or a location in a second stage authentication;
activating verification in the second stage authentication only verification of the first stage authentication passes; and
activating actions regarding operation of the vehicle only verification of the second stage authentication passes.

5. The method as claimed in claim 4, wherein the first module is a BCM (Body Control Module) for operating the vehicle.

6. The method as claimed in claim 5, wherein the second module is of a MCU (microcontroller).

7. The method as claimed in claim 6, wherein a mobile device and a central console are connected to the system to change the preset environment conditions.

8. The method as claimed in claim 7, wherein in the second stage authentication, a live information is preset as the preset condition including face ID or touch ID.
